(19) United States
(12) Patent Application Publication
(10) Pub. No.: US 2017/0024786 A1
(43) Pub. Date: Jan. 26, 2017

(54) Electronic Shopping System and Method for Facilitating the Purchase of Goods and Services of Others

(71) Applicant: Suzanne J. DuBose, Houston, TX (US)

(72) Inventor: Suzanne J. DuBose, Houston, TX (US)

(21) Appl. No.: 14/824,400

(22) Filed: Aug. 12, 2015

Related U.S. Application Data
(60) Provisional application No. 62/194,796, filed on Jul. 20, 2015.

(51) Int. Cl. G06Q 30/06

(52) U.S. Cl. CPC G06Q 30/0603; G06Q 30/0613

(57) ABSTRACT

Disclosed is a system and method enabling the participation of a third-party computer program in a shopping activity between a vendor and a consumer. The system is a software application that resides in part on a consumer smart device and in part on (for example) a publisher's system server. The present system enables the consumer smart device to transform the advertising image from a hardcopy (magazine) page to a digital fingerprint representative of the hardcopy page, and to sent the fingerprint to a publisher system server. The fingerprint is compared against a database of other similarly generated fingerprints of hardcopy pages from the magazine, including the advertising page of interest, for a match. Upon finding a suitable match, the vendor and item information for the items for sale on the advertising page are displayed on the smart device enabling the consumer to browse the information and implement a purchase.

### FIELD OF THE INVENTION

The present invention is in the field of data processing, wherein an electrical apparatus and its corresponding methods perform data processing operations utilized for cost/price determination and the processing of consumer financial data (US Class 705/subclass 1.1). Specifically, the present invention relates to electronic shopping (subclass 26.1), and subject matter drawn to a computerized arrangement which enables a shopper to investigate, locate, specify, requisition, order, or purchase one or more items for sale or trade using a “smart” device configured to include communications functionality for the exchange of information concerning the one or more items. This includes browsing of a selection without a purchase transaction. More specifically, the present invention is drawn to subject matter configured to facilitate and support a third-party computer program's participation in a shopping activity (subclass 26.41).

### BRIEF DESCRIPTION OF THE DRAWINGS

FIG. 1 is a schematic drawing showing an overview of the system which is comprised of a Consumer Device running a consumer software application (Consumer App) communicating via a com-link with a System Server running a server software application (Server App), which in turn communicates via com-links with one or more Vendors.

FIG. 2 is a schematic drawing showing a plurality of Vendors supplying product and services information to the System Server to be integrated into the Server App's database.

FIG. 3 is a flowchart exemplifying a consumer registration process being negotiated between a consumer device and a system server.

FIG. 4 is a schematic drawing illustrating the consumer app on a consumer device instructing the camera on the consumer device to capture a digital image of a hardcopy image (e.g., a magazine page in this example), run an optical recognition process (“OCR” for example) on the digital image and send the resultant data to the server app via a network connection.

FIG. 5 is a schematic drawing illustrating the consumer app and the server app coordinating to give the consumer app information from the system database relevant to the latest OCR query.

FIG. 6a is a flowchart exemplifying a logic process for purchasing items in the “shopping cart” feature of the consumer software app.

FIG. 6b is an illustration showing an order placed by a consumer being parsed by the server app and sent to one or more vendors.

FIG. 6c is an illustration showing the vendor sending the order verification to the server app and the server app passing the information to the consumer app.

FIG. 7 is a flow chart illustrating a transformation process starting with a hardcopy page (e.g., from a printed magazine) and using its image content to reference information in an e-catalogue database regarding an item advertised on the hardcopy page.

FIG. 8 is a flow chart illustrating a method for a third-party computer program's facilitation of a shopping activity between a vendor and a consumer over a global computer network.

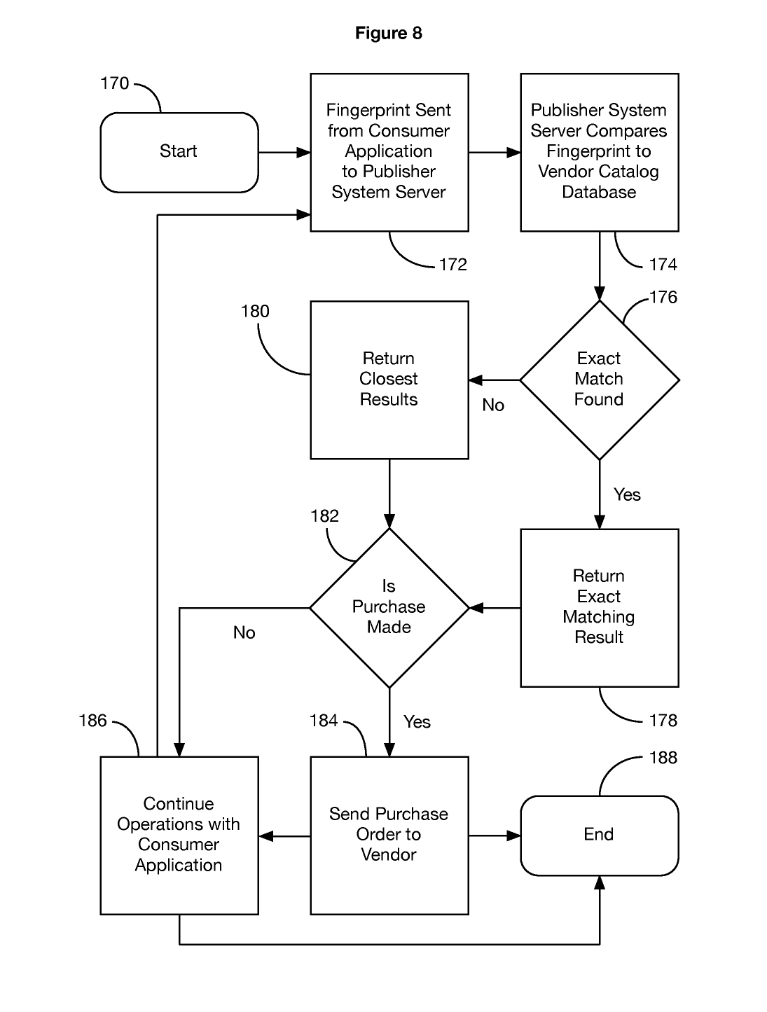

### LIST OF REFERENCE NUMERALS

10 optical recognition system
12 consumer smart device
14 consumer e-catalogue application, including software for transforming HCP (“hardcopy page”) content
18 consumer com-link
20 publisher system server
22 publisher software application
26 point correlation software
30 global communications network
32 vendor com-link
34 vendor
40 consumer device camera
44 image transforming/fingerprinting software
46 HCP digital fingerprint
50 system database
52 vendor/item fingerprint
70 hardcopy page
74 advertised item
100 start registration process
102 create consumer ID & password
104 input (real) consumer name & info
106 run payment sub-process
108 run reg. confirmation sub-process
110 end registration process
120 start purchase process (e.g., load and display “shopping cart” software or other vendor specific purchasing process)
122 send purchase information to publisher server e-catalog application
124 determine vendor(s)
126 retrieve payment & shipping information
128 output purchase order to vendor(s)
130 end purchase process, send order confirmation
150 start transformation process
152 transformation HCP process
154 generate HCP fingerprint
156 match HCP fingerprint to e-catalogue database
158 retrieve vendor/item information from match
160 display vendor/item information
162 end transformation process
170 start assisted shopping process
172 transform HCP content to HCP fingerprint & send to server
174 compare HCP fingerprint to e-catalogue database for HCP fingerprint matches
176 process match results for vendor/item information
178/180 display matching vendor/item information
182 detect a purchase decision
184 initiate vendor/item purchase process
186 continue shopping currently displayed vendor/item information
188 end assisted shopping process

### DESCRIPTION OF THE INVENTION

The present invention is a system and method combining hardware and software to facilitate a consumer's purchase of goods and services from a hardcopy advertising medium, such as print magazines and periodicals. The present inventive system includes a software application, part of which is resident on a system server and part of which is downloadable to a (consumer's) mobile “smart” device. The present system and method enables a consumer to use a mobile smart device to browse information and to purchase goods and services advertised in a hardcopy print medium, the enablement of which is not directly provided for in the hardcopy medium itself (e.g., there is no QR code displayed on the hardcopy page itself).

The present inventive system combines hardware and software to facilitate a consumer's purchase of goods and services from the hardcopy advertising medium using a “smart” device enabled with an image converting/transforming software. A “smart” device for use with the present system is a device such as a smart phone, a tablet-type computing device, and other personally portable computing devices, which have a built in camera and camera function. By using image converting/transforming software (like an optical character recognition program) on a consumer's smart device to analyze a hard copy image (e.g., one or more page in a magazine publication), the present inventive system determines certain information about the magazine and the specific page: e.g., publication name, date of publication, specific page numbers, vendor, etc. The publisher of the image/magazine provides an e-catalogue database on a publisher system server. The e-catalogue database provides information about the products and services on a given page (e.g., vendor, sizes, colors, description, price, availability, etc.). The system will allow the consumer to pick the item or service with its associated options and facilitate the transaction with the seller. The system will gather the associated payment method and shipping address, along with the order, and send as a complete package to the vendor.

Referring now to the drawings, the details of preferred embodiments of the present invention are graphically and schematically illustrated. Like elements in the drawings are represented by like numbers, and any similar elements are represented by like numbers with a different lower case letter suffix.

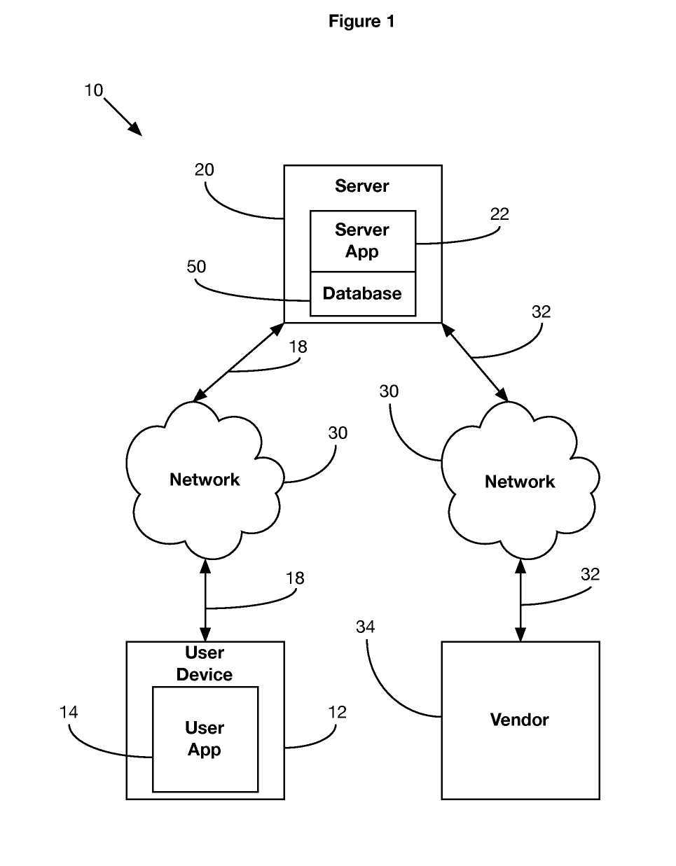

As shown in FIG. 1, the present system 10 for facilitating a shopping activity between a vendor and a consumer comprises: a mobile smart device 12 enabled with the present downloadable consumer software application 14; a publisher system server 20 running the present server e-catalog application 22, and having an e-catalog database 50. The raw content for the e-catalogue database 50 is provided to the publisher system 20 by retailors/vendors 34, for whom the publisher is a third party facilitator of a shopping transaction between a consumer and a vendor.

The figure illustrates a consumer smart device 12 running a downloadable consumer software application 14. The consumer application exchanges communications with the publisher server 20 via a network connection 18 using the smart device 12. One or more vendors 34 also exchange communications with the publisher server 20 via a network connection 32 using an appropriate network communication device (not shown). The consumer device never communicates directly with the vendor in the course of a transaction, and vice versa. All shopping transactions are handled through the third-party publisher. Communications between the consumer smart device 12, the publisher system server 20 and the vendors 34 is accomplished over a global communications network 30, such as the World Wide Web.

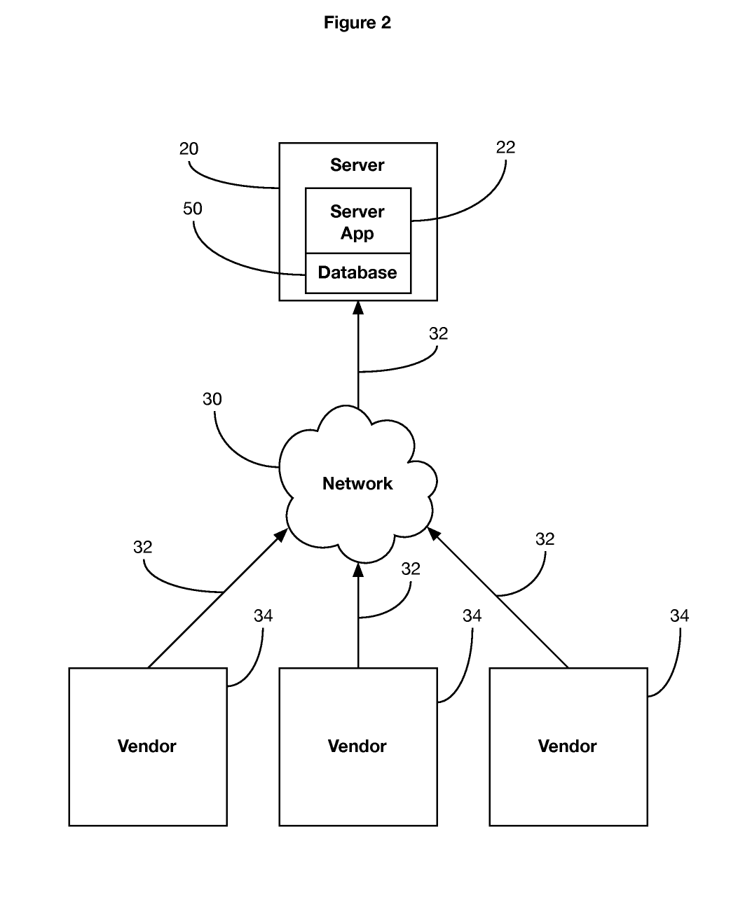

FIG. 2 exemplifies a plurality of vendors 34 supplying product and services information to the publisher system server 20 for the server e-catalog application 22 to integrate into the e-catalogue database 50. Via the network 30, the vendors 34 supply product and services information only to the publisher system 20, not directly to the consumer device 12.

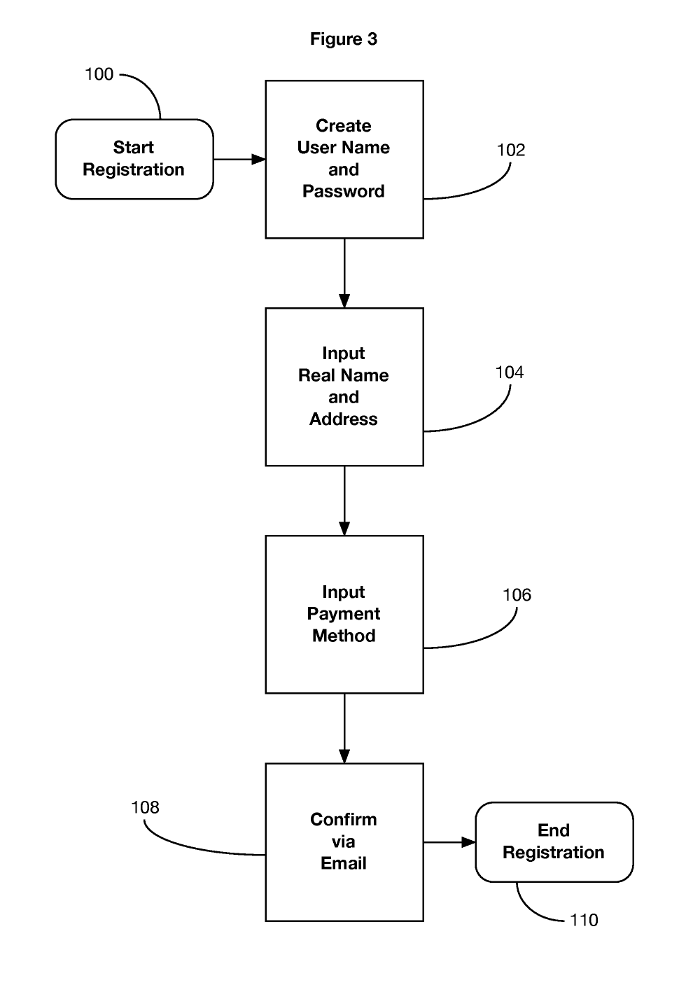

In using the present system 10, a consumer loads the consumer e-catalogue software application 14 onto the consumer's smart device 12. In the embodiment exemplified, it is intended that the consumer downloaded consumer software application 14 from an “app store” (not shown), as is known in the art. The consumer initializes (registers) use of the consumer software application 14 as is typical in the art. FIG. 3 exemplifies such a registration process, wherein the consumer installs the application 14 and starts the registration process 100. In proceeding through the registration process 100, the consumer creates a user/consumer name and password 102; can provide personal information 104; provides payment information 106 and contact information 108 before ending the registration process 110. This information is initiated at the consumer device 12 and then transmitted by the consumer software application 14 to the publisher system server for storage and access as typical for electronic consumer transactions.

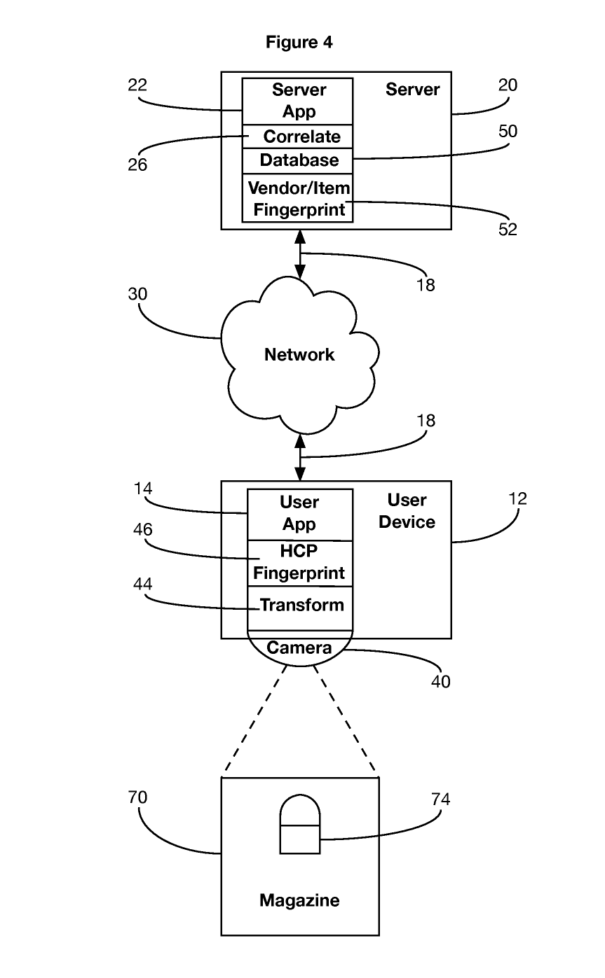

Once the consumer software application 14 is installed and activated on the smart device 12, to practice the present system, the consumer runs the consumer application 14. See FIG. 4. For the sake of illustration, upon browsing a print magazine (e.g., Cosmopolitan®) and finding an advertised item 74 on a hardcopy page 70 in the magazine (e.g., a Gucci® purse), the consumer utilizes the camera function 40 of the smart device 12 to acquire an image of the advertised item 74 from the page 70 and of the cover (not shown) of the magazine. The image transforming/fingerprinting software 44 of the consumer application 14 transforms content (e.g., alpha/numeric content, image content, image character characteristic content) of one or more of the hardcopy (advertisement & cover) pages 70 and from the transformed content generates a consumer “HCP digital fingerprint” 46. The HCP digital fingerprint 46 embodies electronic transformation of the image content of the hardcopy pages 70, including the advertised item 74 depicted on the page(s), and indicia of the source magazine (and a page number). The consumer smart device 12 then transmits the HCP digital fingerprint 46 of the transformed content 44 to the e-catalog application 22 of the publisher system server 20 for comparison against the e-catalogue database 50. It should be noted that in this example the transformed content 44 and the HCP fingerprint 46 are generated at the consumer smart device 12. However, in certain circumstances known to the ordinary skilled artisan, the present invention may practice by transmitting the transformed image content 44 to the e-catalog application 22 to have the HCP digital fingerprint 46 generated there.

The publisher system server 20 is a computer server as is understood in the current vernacular of the field and is connectable to the network 30. The publisher system server 20 hosts and runs the present publisher server e-catalog application 22 and the e-catalog database 50. Upon acquiring an HCP digital fingerprint 46 from the consumer application 14, the server e-catalog application 22 compares the HCP fingerprint 46 against the vendor/item fingerprints 52 of the e-catalogue database 50.

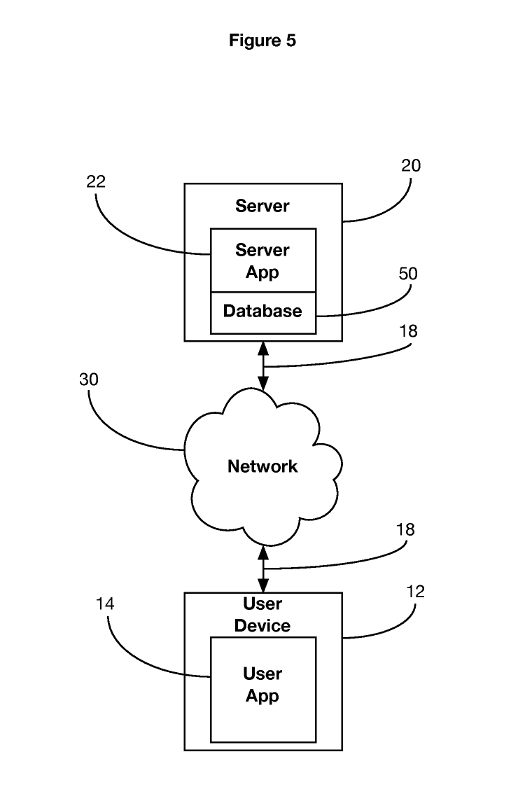

Upon finding a corresponding vendor/item e-catalogue fingerprint 52 for an item entry in the e-catalogue database 50, the item information for that entry is transmitted back to the consumer device 12 to display/presentation to the consumer the related content for that item from the e-catalog database 50. See FIG. 5. If no exact matches are found, a “points of correlation” process 26 is run by the server e-catalog application 22 to identify one or more of the most closely corresponding vendor/item fingerprints 52 that match the digital fingerprint 46. In this situation, the information for the most closely corresponding item entry/entries is transmitted back to the consumer device 12 for display/presentation to the consumer by the consumer software application 14.

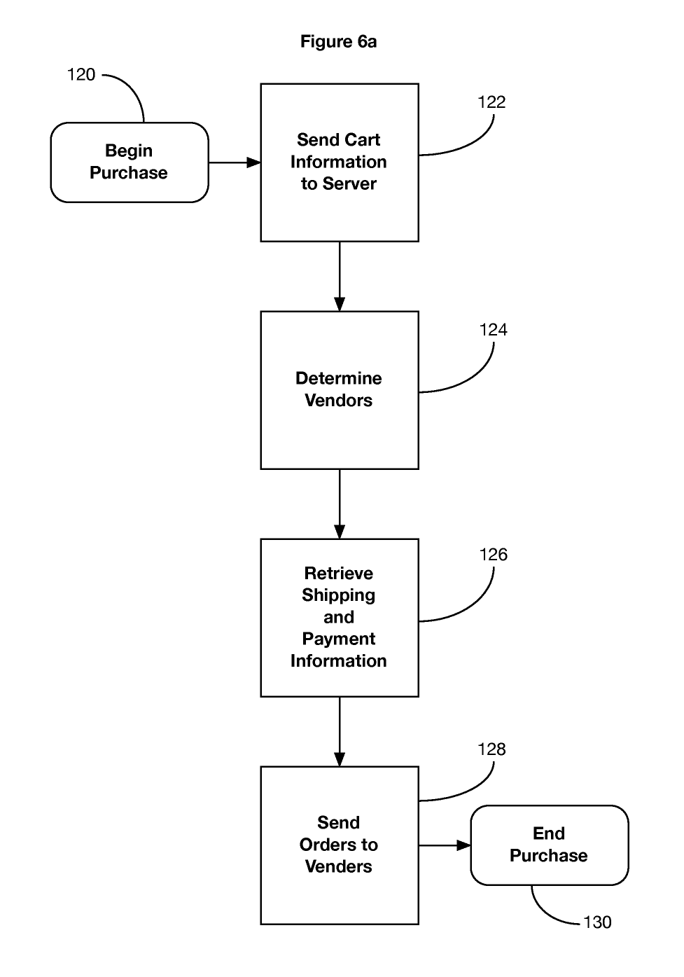

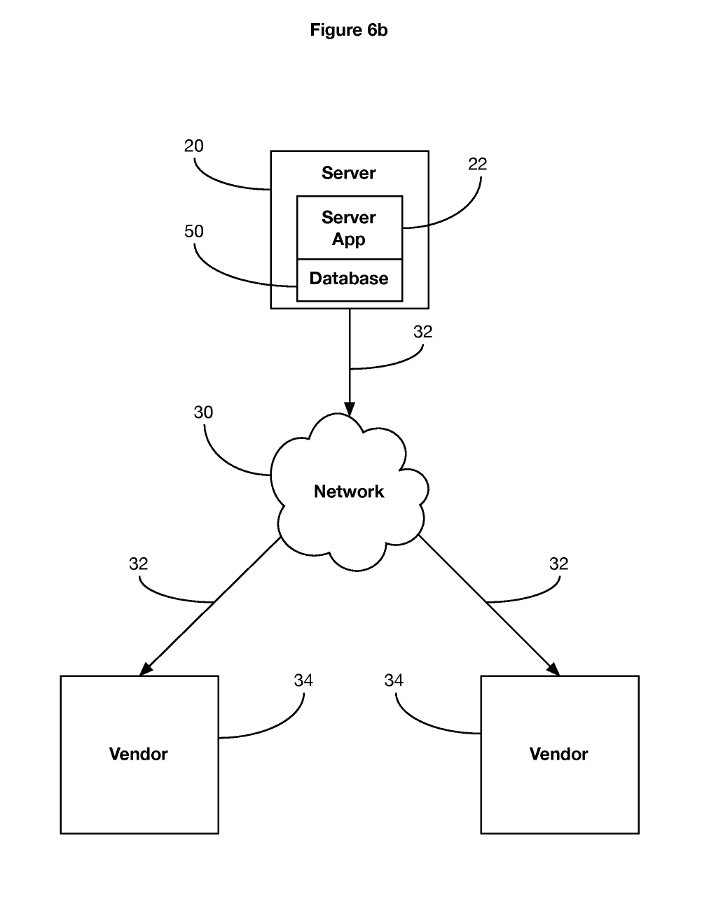

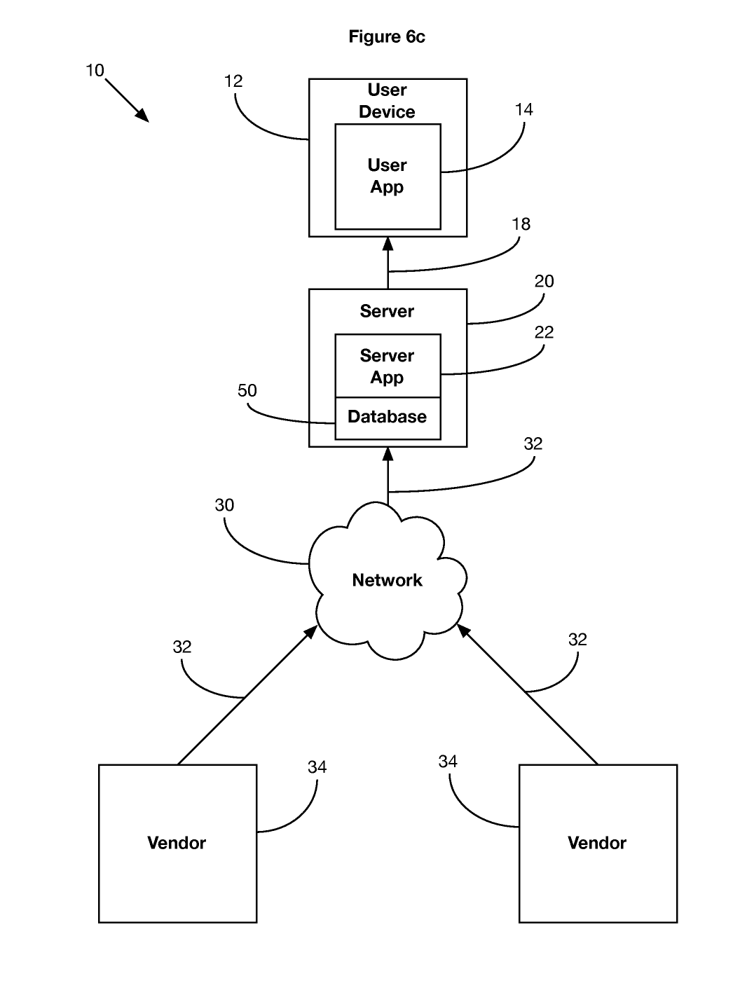

The item information is received by the consumer software application 14 and displayed on the consumer smart device 12 and can be viewed/browsed by the consumer to inform and to facilitate a purchase decision. Also displayed will be information and functionality necessary to enable the consumer to purchase the item. If the consumer desires to purchase the displayed item, the consumer software application 14 provides electronic purchase functionality as is currently known in the art. FIG. 6a exemplifies such an electronic purchase process, wherein the consumer begins the purchase process 120 and sends 122 the item purchase information to the e-catalog application 22 of the publisher system server 20. In view of the purchase information sent, the e-catalog application 22 identifies the vendor(s) 124 for the item; retrieves payment/shipping information 126 from the database 50, and prepares and sends a purchase/payment order 128 to the vendor(s). In completing the process 130, an order confirmation is sent back to the consumer software application 14 for the consumer's records.

FIG. 6b illustrates how a purchase/payment order generated by the server e-catalog application 22 is sent to one or more vendors 34. In the embodiment illustrated, the vendor 34 processes the payment order and ships the item to the consumer. Alternatively, as shown in FIG. 6c, a vendor can send the order verification to the e-catalog application 22 and the publisher system server 20 can pass the information on to the consumer software application 14 on the consumer's smart device 12.

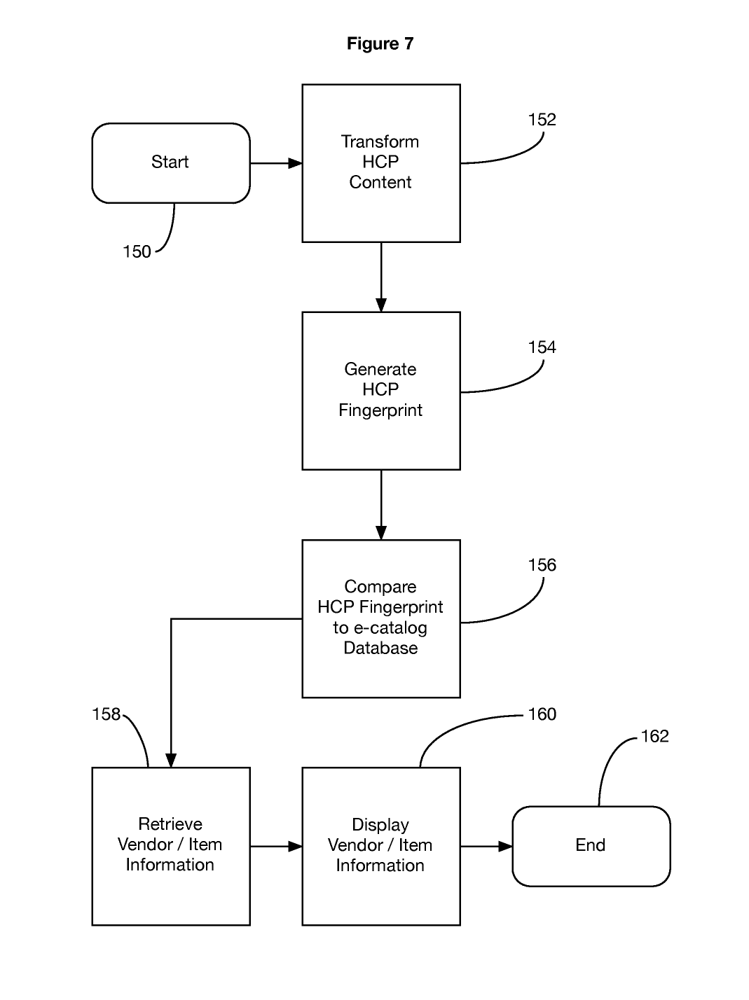

In practicing a method of the present invention wherein the system participates in a shopping activity between a vendor and a consumer (see FIGS. 7 & 8), the consumer utilizes a smart device 12 having the present downloadable consumer e-catalogue software application 14. After the consumer has identified an item for sale depicted on (say) a hardcopy magazine page 70, he/she starts the shopping process 150, 170. A first step in the shopping process 150 is to transform 152 the image content of the hardcopy magazine page 70 to a digital content/format, and then from the digital content/format to generate 154 an HCP fingerprint 46 representative of the printed content (advertisement) of the original hardcopy page 70 advertising one or more consumer items for sale. This is accomplished by HCP transforming and fingerprint generating software 44. The HCP fingerprint 46 is sent 172 to the publisher system server 20 for processing by the publisher server e-catalog application 22. In a following step, the HCP fingerprint 46 is compared 156, 174 to the vendor e-catalogue database 50 and a matching process 176 determines one or more appropriately matching vendor item/entries. If the matching process 176 finds an exact match with a vendor item/entry, the resulting vendor/item information is returned 178. Absent an exact match, one or more of the closest matching vendor/item information sets is returned 180.

Once one or more appropriately matching item/entries fingerprint is/are found, the stored vendor/item information related to the consumer item advertised on the hardcopy page 70 is retrieved 158 from the vendor e-catalogue database 50 and sent to the smart device 12. The consumer's smart device 12 then displays 160 the vendor/item information of the item/entry in the e-catalogue database 50 corresponding to the item/entry fingerprint, enabling the consumer to browse the vendor/item information and/or to purchase 182 the consumer item of the item/entry. The consumer transmits a purchase decision 120, 182 to the publisher e-catalogue software application 22, which receives, processes and outputs 184 the purchase order. The purchase order for the item for sale is output to a vendor 34 of the vendor/item entry in the vendor e-catalogue database 50 to complete 188 the shopping activity between the vendor and the consumer. Alternatively, the consumer may choose to continue shopping 186 the currently displayed vendor/item information.

Thus, the content of hardcopy advertising page 70 in a magazine can be transformed into digital content unrelated to the subject mater content of the original HCP 70. Then the digital content is used to generate a fingerprint 46. The fingerprint 46 is then usable to link to matchup with information related to the subject matter content of the HCP 70 in the vendor/item database 50. At the process end 162, 188, the shopping activity between the vendor and the consumer has been facilitated by the present system and method.

In accomplishing the e-catalogue database 50 of the present invention, a vendor supplies to the publisher system server 20 the specific information (i.e., size, color, availability, etc.) for each of their vendor/item entries in the e-catalogue database 50. The unique vendor/item e-catalogue fingerprint 52 for each vendor/item entry in the e-catalogue database 50, is generated by the publisher using basically the same transformation/fingerprinting process that the consumer smart device 12 utilizes to generate transformed HCP content 44 and thence a “digital fingerprint” 46. See above. Using the hardcopy page example of a consumer magazine, this is to say a page in the magazine having advertising content on it (i.e., items for sale), is processed by the present image transforming/fingerprinting software 44 at the publisher server to generate a digital fingerprint of the HCP the same way a consumer would with a smart device 12 loaded with the consumer e-catalogue application 14. The resulting vendor/item e-catalogue fingerprint 52 is substantially identical to the HCP fingerprint 46 that the consumer smart device would generate from the same hardcopy page, and thus can be searched and matched-up in the database 50.

The unique vendor/item e-catalogue fingerprint 52 is linked to the specific item and its information in the e-catalogue database, and allows the specific item and its information to be called up using the consumer device generated digital fingerprint 46. As the publisher of the magazine, the publisher already has access to the source of the hardcopy advertising pages of the subject magazine. Alternatively, the vendors can provide content copy of the advertising pages to the publisher.

### Purpose:

The purpose of the present system & method 10 is to assist a publisher in turning an entire hard copy print format (such as a magazine) into a virtual e-catalog. If a consumer sees an item in the magazine, the present system & method 10 enables the consumer to electronically browse additional information about the item and to purchase it. This is achieved without disturbing the magazine layout or content (i.e. no barcodes, watermarks, etc.).

### Scope:

The application will work with any pages of a magazine that display advertised products relative to which the present system is implemented. The consumer will use a “smart” device enabled with the present software to identify the magazine and a page of the magazine by taking a picture of the cover of the magazine to identify it, and of the page showing the advertised items. Alternatively, the consumer can merely enter the name and issue of the magazine to identify it. The application compares optically recognized characters from the camera image(s) with the system database to identify the items in the page image and their associated features and options. The consumer can then pick the item with its associated options and quantities and add them to a “shopping cart” feature of the application.

The application defaults to the Home screen when it is launched. A tutorial popup can launch as desired when the application is launched and provide some basic use instructions. It should be mostly (50%+) opaque and easily dismissed from the screen. The present software application is intended to provide a “shopping cart” function (see below for information on the Cart).

The Home screen should consist of three buttons;
1. Log In/Out (text on this button changes to reflect the current log status). The application will accept any consumer name and password and will send email to a fixed address.
1.1. If there is no consumer logged in to the application then this button should read “Log In.”
1.1.1. When there is no consumer logged in the “Camera” option should be greyed out or dimmed.
1.1.2. If the consumer presses the button, the application should use a popup window dialog, with animation, asking the consumer to input a consumer name and password.
1.1.3. Authenticated log in credentials should be accepted.
1.1.4. The popup window should have a “Cancel” button which, if pressed, dismisses the popup dialog, with animation, and returns to the home screen in its default state.
1.1.5. The popup dialog should have an “OK” button which logs the consumer in with the supplied credentials and dismiss the popup window with animation;
When a consumer is logged in there should be status information (consumer name, number of payment methods available, number of purchases pending and a picture of the consumer).
   1.1.6. The “Photo” button should stop being greyed or dimmed and become colorized so that it is apparent that the option is now available.
   1.2. If there is a consumer logged in the button should say “Log Out.”
   1.2.1. If the consumer presses the button, a confirmation dialog should pop up and ask if the consumer is sure that they want to log out.
   1.2.1.1. The popup should have an “OK” button which dismisses the popup window, with animation, and returns the application to its default state with no consumer logged in.
   1.2.1.2. The popup should have a ‘Cancel” button which dismisses the popup dialog, with animation, and returns the application to its state just before the consumer initiated the “Log Out” command.
   2. Camera (this button could have other names)
   2.1. When this button is pressed the device should switch to camera mode.
   2.2. The camera's viewfinder should have the following elements:
   3. A ‘Scan’ button;
   3.1. The consumer points the camera at the magazine so that the footer (magazine name, issue number/month, year and page number) is inside of the reticle in the center of the viewfinder (the orientation of the camera can be portrait or landscape (whichever orientation is determined to facilitate the required functionality) and presses the button.
   3.2. The image is run through an OCR (optical character recognition) process to determine the page number.
   3.2.1. If a page number is not found the reticle flashes red and the application is left in the camera's viewfinder mode so that the consumer can try again;
   3.2.2. If a page number is found the Reticle flashes green (the viewfinder is left in this state for 2 seconds before leaving camera mode, returning to the Home page and using a popup window to display the relevant content of the page that was scanned. This depends on the library that will be used.
   3.3. Using the database the popup from a successful scan should be populated with the relevant product information (item photo, item description, color, size and quantity), multiple items on a page are displayed inline and scrollable with their relevant information.
   3.3.1. Items color, size and quantity should have a drop down menu populated with the relevant options so that the consumer may select from among them.
   3.3.2. There should be a button at the end of each item's options which says “add to cart.”

The cart needs to remember which items and which options have been chosen and keep a running total on the cost so that during the purchase phase and the subsequent confirmation email will be able to inform the consumer of the final price and what was purchased

There should two buttons at the end of the list that say ‘Done” and “Checkout.” The Done button should dismiss the popup window, with animation, and return the consumer back to the camera mode so that they may scan additional pages and add more items to the Cart.

The Checkout button should replace the current popup window with a new popup window (use an animated transition) showing the contents of the Cart and a total purchase price. The new popup window should have two buttons at the bottom of the application saying “Purchase” and “Cancel.”

The Purchase button should replace the current popup window with a new popup window (using the same transition animation as before) stating that the purchase has been made and send a confirmation email to a pre-established email account.

The Cancel button should dismiss the popup window, with animation, and return the consumer to the camera's viewfinder with the contents of the cart intact. When the “Cancel” button, the camera's viewfinder should be dismissed and the consumer should be returned to the Home screen with the contents of the cart, if any, intact.

4. Options (the options can be displayed on a full page or on a popup window with animation).
4.1. Theme option which can be toggled (current selection should be highlighted).
4.1.1. Light theme with a white background;
4.1.2. Dark theme with a black background;
4.1.3. Text and foreground colors should be modified, if needed, to maintain readability.
4.2. Text size buttons: “Small,” “Normal” (default highlighted); and “large.” These buttons should change their highlight when pressed, and resizing the text as necessary.
4.3. Payment Method button (highlight when touched)
4.4. Account Information button (highlight when touched).
4.5. Support button (highlight when touched).
5. The application should be terminated if the consumer activates the operating systems default button for exiting an application.
Below is a list of features/cases that will be available to the user for demonstration:

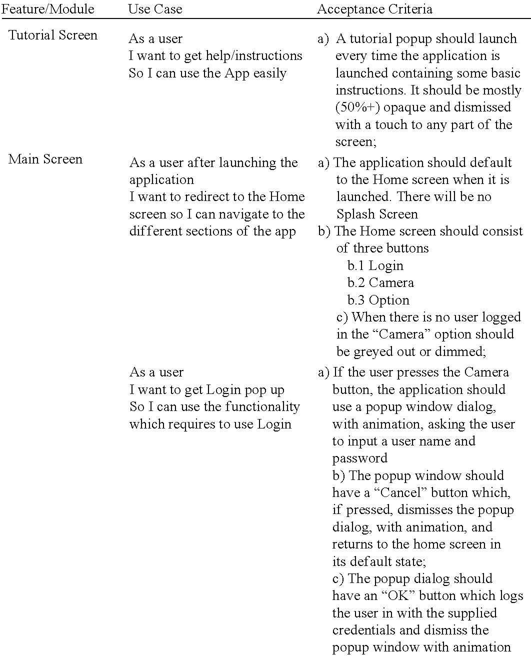

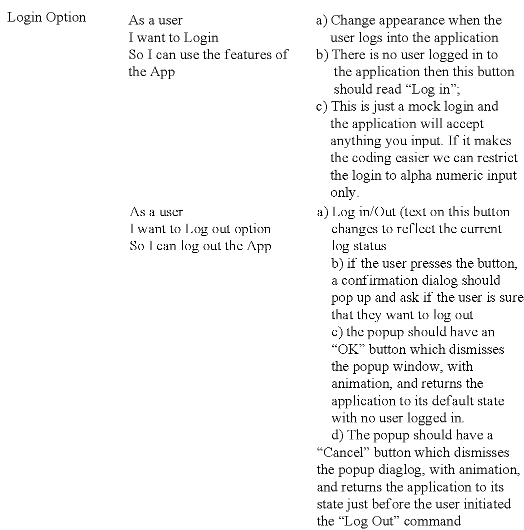

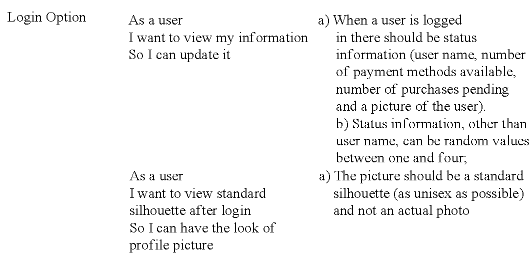

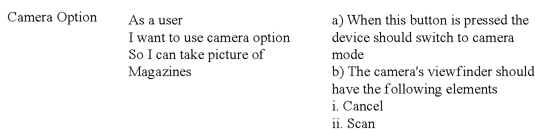

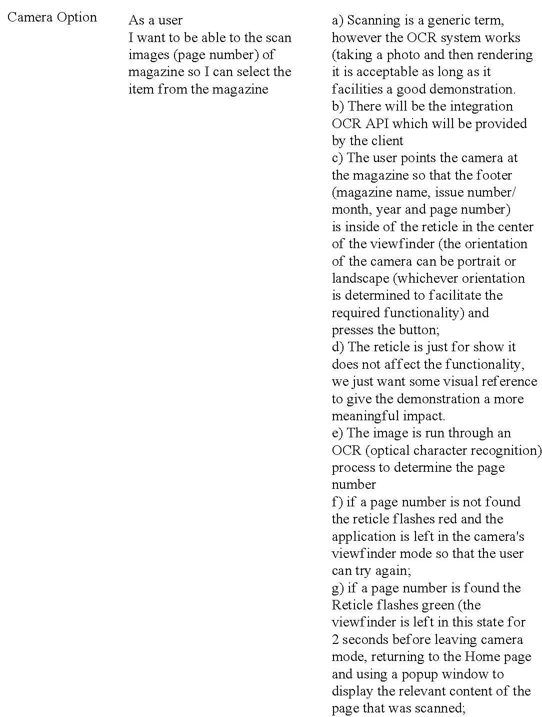

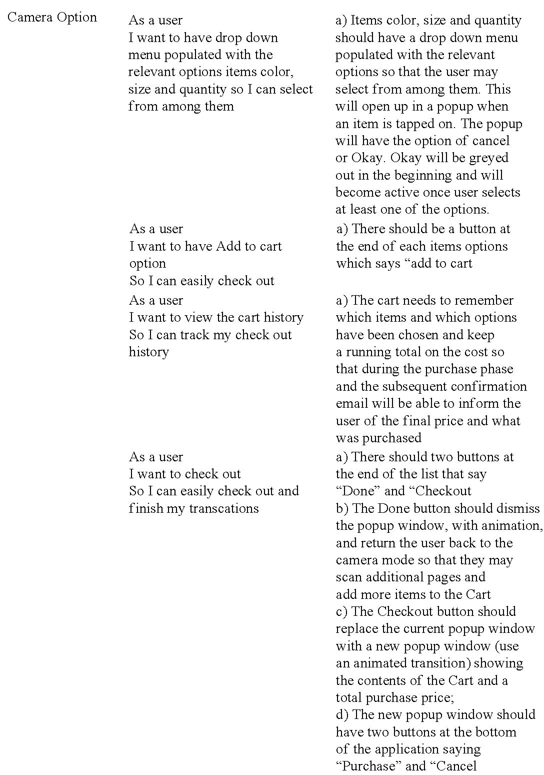

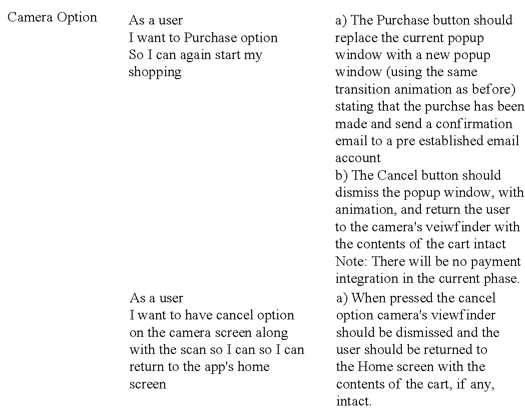

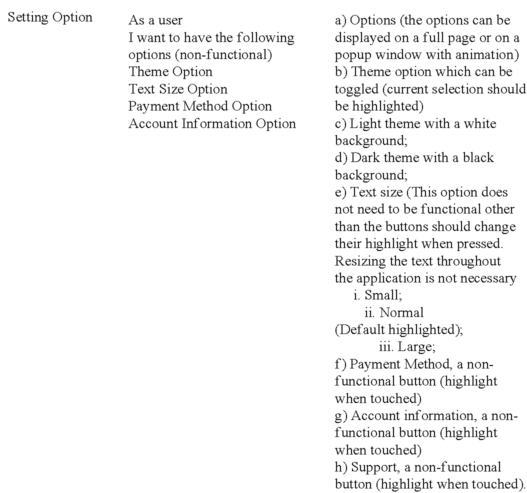

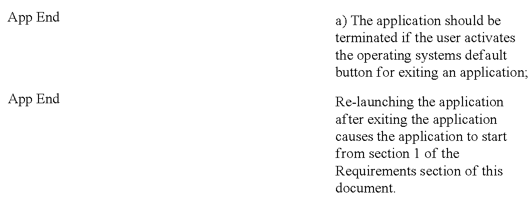

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A system (10) facilitating the purchase of goods and services of others using, the system comprising:
a smart device (12) having a downloadable consumer e-catalog application (14), the smart device (12) in communication with a publisher system server (20), the consumer e-catalogue application (12) including hardcopy page transforming software adapted to transform a content of a hard copy advertisement page to a digitally recognizable content (46) and to transmit the digitally recognizable content (46) via a consumer network connection (18) to the publisher system server (20) in the form of a database query;
the publisher system server (20) having a publisher e-catalogue application (22) and a vendor e-catalog database (50), the publisher system server (20) receives the database query, searches the vendor e-catalog database (50) and responds via the consumer network connection (18) to the consumer smart device (12) with a responsive catalogue content from the vendor e-catalog database (50), the responsive catalogue content related to the recognized content (46) of the database query, and forwards to a vendor of responsive catalogue content a notice of the database query; and
the responsive catalogue content being loaded onto the publisher e-catalog database (50) by the vendor (34) via the vendor network connection (32) and related in the database (50) to the digitally recognizable content (46), so that the responsive catalogue content is linked to and searchable in the vendor e-catalogue database (50) by the related digitally recognizable content (46).

2. A method of participation in a shopping activity between a vendor and a consumer by a third-party computer program (10), the method comprising the steps of:
generating (154) a HCP fingerprint (46) from a printed content of a hardcopy page (70) advertising a consumer item by utilizing a smart device (12) of the consumer having a downloadable HCP transforming and fingerprint generating software (44);
comparing (156) the HCP fingerprint (46) to a vendor e-catalogue database (50) for a corresponding item/entry fingerprint referencing stored vendor/item information related to the consumer item advertised on the hardcopy page (70); and
displaying (160) on the smart device (12) of the consumer, the vendor/item information of the item/entry in the e-catalogue database (50) corresponding to the item/entry fingerprint, and enabling the consumer to purchase (182) the consumer item of the item/entry to facilitate the shopping activity between the vendor and the consumer.

3. A method of participation in a shopping activity between a vendor and a consumer by a third-party computer program (10), the method comprising the steps of:
providing a consumer shopping application (14) having HCP transforming software (44) downloaded onto a consumer smart device (12), the HCP transforming software (44) adapted for viewing and transforming (152) a viewed printed content into an HCP data structure derived from the viewed printed content, for generating (154) an HCP fingerprint (46) from the HCP data structure, and for sending (172) the HCP fingerprint (46) as a data query to a publisher system server (20) via a global communications network (30);
running the publisher system server (20) on the global communications network (30), the publisher system server (20) having a publisher e-catalogue software application (22) and a vendor e-catalog database (50), the publisher system server (20) adapted for receiving (172) the data query from the consumer smart device (12), and comparing (174) the HCP fingerprint (46) of the data query against the vendor e-catalogue database (50) and finding (176) a match between the content of the hardcopy page (70) represented by the HCP fingerprint (46) and a vendor/item entry in the vendor e-catalogue database (50);
replying to the data query by transmitting (178, 180) and displaying (160) the vendor/item entry on the consumer smart device (10) to enable the consumer to browse the vendor/item entry of the vendor e-catalogue database (50) and to initiate a purchase order for an item for sale depicted in the hardcopy advertisement page (70) and in the vendor e-catalogue database (50) by transmitting (182) the purchase order to the publisher system server (20) via the global communications network (30);
receiving and processing (184) the purchase order by the publisher e-catalogue application at the system server (20); and
outputting (184) the purchase order for the item for sale to a vendor (34) of the vendor/item entry in the vendor e-catalogue database (50) to complete (188) the shopping activity between the vendor and the consumer.

4. The method of claim 3, wherein the step of running the publisher system server (20) comprises:
running a publisher system server (20) on the global communications network (30), the publisher system server (20) having a publisher e-catalogue software application (22) and a vendor e-catalog database (50) containing a vendor/item entry, the vendor/item entry having an ID content, a vendor information content and an item for sale content, and the publisher system server (20) adapted for receiving (172) the data query from the consumer smart device (12), and comparing (174) the HCP fingerprint (46) of the data query against the vendor e-catalogue database (50) and finding (176) a match between the content of the hardcopy page (70) represented by the HCP fingerprint (46) and a vendor/item entry in the vendor e-catalogue database (50).
